(19) United States
(12) Patent Application Publication
(10) Pub. No.: US 2026/0021504 A1
(43) Pub. Date: Jan. 22, 2026

(54) COATING DEVICE AND METHOD OF DRIVING THE SAME

(71) Applicant: Samsung Display Co., LTD., Yongin-si (KR)

(72) Inventor: JONGIK LEE, Yongin-si (KR)

(21) Appl. No.: 19/095,502

(22) Filed: Mar. 31, 2025

(30) Foreign Application Priority Data
Jul. 17, 2024 (KR) 10-2024-0094351

(51) Int. Cl. B05B 13/02; B05B 13/04; B05B 15/50

(52) U.S. Cl. CPC B05B 13/0221; B05B 13/041; B05B 15/50

(57) ABSTRACT

A coating device includes a first guide rail arranged in a stage area and extending in a first direction, a second guide rail arranged in the stage area and a maintenance area and extending in the first direction, a first and second stage structures arranged on the first guide rail and each movable in the first direction or in a direction opposite to the first direction by the first guide rail, and a discharger arranged on the second guide rail and movable in the first direction or in the direction opposite to the first direction by the second guide rail.

This application claims priority to Korean Patent Application No. 10-2024-0094351, filed on Jul. 17, 2024, and all the benefits accruing therefrom under 35 U.S.C. § 119, the content of which in its entirety is herein incorporated by reference.

### BACKGROUND

### 1. Field

Embodiments relate to a coating device and a method of driving the coating device.

### 2. Description of the Related Art

In a manufacturing process of an electronic device, various coating devices such as a dispenser an inkjet printing device, or the like may be used to form layers included in the electronic device. The coating device may include a head, and the head may discharge an organic material, an insulating material, or the like on an object through a nozzle. In this case, the coating device may perform coating by discharging a droplet from the nozzle of the head toward the object while changing a relative position of the head and the object.

### SUMMARY

Embodiments provide a coating device with improved productivity.

Embodiments provide a method of driving the coating device.

A coating device according to an embodiment of the disclosure includes a first guide rail arranged in a stage area and extending in a first direction, a second guide rail arranged in the stage area and a maintenance area adjacent to the stage area and extending in the first direction, a first stage structure arranged on the first guide rail and movable in the first direction or in a direction opposite to the first direction by the first guide rail, a second stage structure arranged on the first guide rail and movable in the first direction or in the direction opposite to the first direction by the first guide rail, and a discharger arranged on the second guide rail and movable in the first direction or in the direction opposite to the first direction by the second guide rail.

In an embodiment, the coating device may further include a third guide rail arranged on the second guide rail and extending in a second direction intersecting the first direction, and the discharger may be movable in the second direction or in a direction opposite to the second direction by the third guide rail.

In an embodiment, the coating device may further include a fourth guide rail arranged on the third guide rail and extending in a third direction intersecting each of the first direction and the second direction, and the discharger may be movable in the third direction or in a direction opposite to the third direction by the fourth guide rail.

In an embodiment, the discharger may include a plurality of heads each including a nozzle, and each of the plurality of heads may be connected to the second guide rail, the third guide rail, and the fourth guide rail.

In an embodiment, the plurality of heads may be movable independently of each other.

In an embodiment, the first stage structure may include a stage on which a substrate is seated, and the second stage structure may include a cassette which cleans the nozzle.

In an embodiment, wherein the second guide rail may include a first connection portion which is connected to the third guide rail and moves the third guide rail, and a second connection portion which is connected to the third guide rail and supports the third guide rail.

In an embodiment, the first connection portion and the second connection portion may be arranged alternately with each other along the first direction.

In an embodiment, the coating device may further include an imager arranged in the stage area, and a third stage structure arranged in the stage area and including a measurer.

In an embodiment, the stage area may include a first area, a second area adjacent to the first area, and a third area adjacent to the second area, the imager may be arranged in the first area, and the third stage structure may be arranged in the third area.

In an embodiment, the first stage structure may be movable in the first area and the second area, and the second stage structure may be movable in the second area and the third area.

A method of driving a coating device according to an embodiment of the disclosure includes maintaining a discharger in a maintenance area, measuring a droplet discharged from the discharger in a stage area adjacent to the maintenance area, coating the droplet on a substrate seated on a first stage structure in the stage area, and cleaning the discharger in the stage area.

In an embodiment, the first stage structure may be movable in a first direction or in a direction opposite to the first direction by a first guide rail, and the first guide rail may extend in the first direction in the stage area.

In an embodiment, the discharger may be movable in the first direction or in the direction opposite to the first direction by a second guide rail, and the second guide rail may extend in the first direction in the maintenance area and the stage area.

In an embodiment, the discharger may be movable in a second direction intersecting the first direction or in a direction opposite to the second direction by a third guide rail, and the third guide rail may be arranged on the second guide rail and extend in the second direction.

In an embodiment, the discharger may be movable in a third direction intersecting each of the first direction and the second direction or in a direction opposite to the third direction by a fourth guide rail, and the fourth guide rail may be arranged on the third guide rail and extend in the third direction.

In an embodiment, the coating the droplet on the substrate seated on the first stage structure may include moving the first stage structure in the first direction, moving the discharger in the second direction, and moving the first stage structure in the direction opposite to the first direction.

In an embodiment, in the cleaning the discharger, the discharger may be cleaned by a second stage structure, and the second stage structure may include a cassette and be movable in the first direction or in the direction opposite to the first direction by the first guide rail.

In an embodiment, the cleaning the discharger may include moving the first stage structure in the first direction along the first guide rail, and moving the second stage structure in the first direction along the first guide rail.

In an embodiment, the moving the first stage structure and the moving of the second stage structure may be performed simultaneously with each other.

In a coating device according to embodiments of the disclosure, the coating device may include multi-axis guide rails and heads connected to the guide rails. In such embodiments, the coating device may have a relatively simple structure without including a separate gantry structure, such that particles that may be generated while driving the coating device may be minimized, and access to maintenance may be improved. In such embodiments, the heads may be driven independently of each other and moved multi-axially respectively by the guide rails, such that productivity of the coating device may be improved.

### BRIEF DESCRIPTION OF THE DRAWINGS

FIGS. 1A and 1B are perspective views illustrating a coating device according to an embodiment of the disclosure.

FIG. 2 is a plan view illustrating the coating device of FIGS. 1A and 1B.

FIGS. 3, 4, and 5 are perspective views illustrating components included in the coating device of FIGS. 1A and 1B.

FIGS. 6, 7, 8A, 8B, 9, and 10 are plan views illustrating a method of driving a coating device according to an embodiment of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the disclosure will be described in more detail with reference to the accompanying drawings. The same reference numerals are used for the same components in the drawings, and any repetitive detailed descriptions of the same components will be omitted.

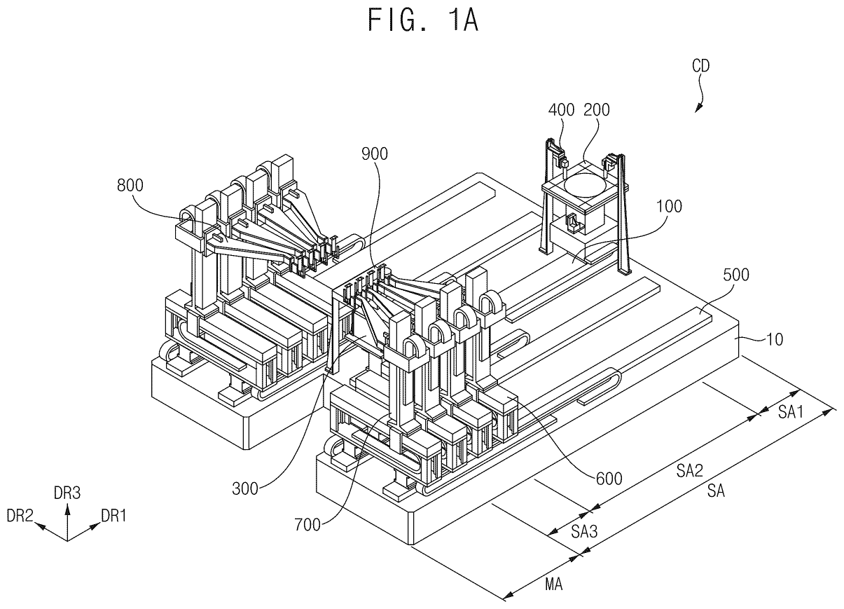

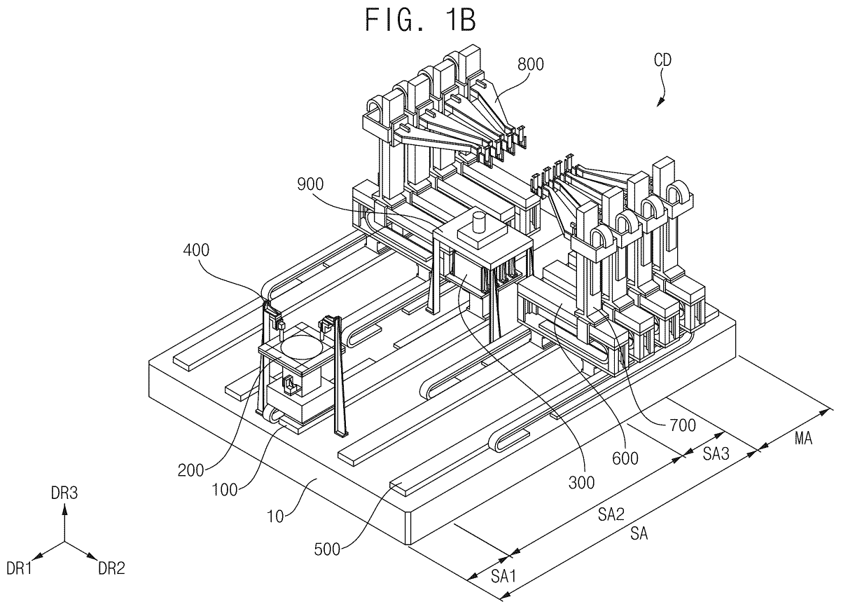

FIGS. 1A and 1B are perspective views illustrating a coating device according to an embodiment of the disclosure.

Referring to FIGS. 1A and 1B, an embodiment of a coating device CD may include a plate 10, a first guide rail 100, a first stage structure 200, a second stage structure 300, an imager 400, a second guide rail 500, a third guide rail 600, a fourth guide rail 700, a discharger 800, and a third stage structure 900.

An embodiment of the coating device CD may be used in a manufacturing process of a display device. For example, the coating device CD may be used in a process of applying a filler on an object during the manufacturing process of the display device. However, the disclosure is not limited thereto, and the coating device CD may be used in various processes of coating (or applying) droplets during the manufacturing process of the display device.

The object may be a display device being manufactured. In an embodiment, the object may be a mother substrate including display devices being manufactured. The object may include silicon, glass, plastic, or the like. In addition, for example, the object may further include at least one selected from an inorganic layer, an organic layer, and a metal layer included in the display device. In an embodiment, the object may be a silicon wafer.

However, the disclosure is not limited thereto, and in an embodiment, the object may be a window included in the display device. In such an embodiment, for example, the object may include glass, a transparent polymer material, or the like.

In an embodiment, the display device may be a micro light emitting diode display device including a micro light emitting diode as a light emitting element. However, the disclosure is not limited thereto, and in an embodiment, the display device may be an organic light emitting diode display device including an organic light emitting diode as a light emitting element.

The plate 10 may be parallel to a plane defined by a first direction DR1 and a second direction DR2 intersecting the first direction DR1. That is, the plate 10 may have a surface (e.g., an upper surface) parallel to the plane defined by the first direction DR1 and the second direction DR2. For example, the first direction DR1 and the second direction DR2 may be perpendicular to each other. The plate 10 may include a maintenance area MA and a stage area SA. The stage area SA may be adjacent to the maintenance area MA in the first direction DR1. The stage area SA may include a first area SA1, a second area SA2, and a third area SA3. The second area SA2 may be adjacent to the third area SA3 in the first direction DR1, and the first area SA1 may be adjacent to the second area SA2 in the first direction DR1.

The first guide rail 100 may be arranged (or disposed) on the plate 10. In an embodiment, for example, the first guide rail 100 may be fixed in the stage area SA on the plate 10. The first guide rail 100 may linearly extend in the first direction DR1. In an embodiment, for example, the first guide rail 100 may not be arranged in the maintenance area MA, and may define the stage area SA and the maintenance area MA.

The first stage structure 200 may be arranged on the first guide rail 100. The first stage structure 200 may be connected to (e.g., slidably engaged with) the first guide rail 100. In an embodiment, the first stage structure 200 may linearly move in the first direction DR1 by the first guide rail 100. In such an embodiment, the first stage structure 200 may be movable in the first direction DR1 or a direction opposite to the first direction DR1 along the first guide rail 100. In an embodiment, for example, the first stage structure 200 may be movable in the first area SA1 and the second area SA2 in the first direction DR1 or the direction opposite to the first direction DR1 along the first guide rail 100.

The second stage structure 300 may be arranged on the first guide rail 100. The second stage structure 300 and the first stage structure 200 may be arranged on the first guide rail 100 in the first direction DR1. The second stage structure 300 may be connected to (e.g., slidably engaged with) the first guide rail 100. In an embodiment, the second stage structure 300 may linearly move in the first direction DR1 by the first guide rail 100. In such an embodiment, the second stage structure 300 may be movable in the first direction DR1 or in the direction opposite to the first direction DR1 along the first guide rail 100. In an embodiment, for example, the second stage structure 300 may be movable in the second area SA2 and the third area SA3 in the first direction DR1 or the direction opposite to the first direction DR1 along the first guide rail 100.

The imager 400 may be arranged in the stage area SA on the plate 10. In an embodiment, for example, the imager 400 may be fixed in the first area SA1 on the plate 10. The imager 400 and the first stage structure 200 may define the first area SA1. The imager 400 may extend from the plate 10 in a third direction DR3 intersecting each of the first direction DR1 and the second direction DR2. For example, the third direction DR3 may be perpendicular to each of the first direction DR1 and the second direction DR2. The third direction DR3 may be a thickness direction of the plate 10. The imager 400 may capture an image in a direction opposite to the third direction DR3. In an embodiment, for example, the imager 400 may capture an image of at least a portion of the object seated on the first stage structure 200. In an embodiment, for example, the imager 400 may include a camera module.

The second guide rail 500 may be arranged on the plate 10. In an embodiment, for example, the second guide rail 500 may be fixed in the stage area SA and the maintenance area MA on the plate 10. The second guide rail 500 may linearly extend in the first direction DR1.

The third guide rail 600 may be arranged above the second guide rail 500. The third guide rail 600 may linearly extend in the second direction DR2. The third guide rail 600 may be connected to (e.g., slidably engaged with) the second guide rail 500. In an embodiment, the third guide rail 600 may linearly move in the first direction DR1 by the second guide rail 500. That is, the third guide rail 600 may be movable in the first direction DR1 or the direction opposite to the first direction DR1 along the second guide rail 500. In an embodiment, for example, the third guide rail 600 may be movable in the maintenance area MA and the stage area SA in the first direction DR1 or the direction opposite to the first direction DR1 along the second guide rail 500.

The fourth guide rail 700 may be arranged on the third guide rail 600. The fourth guide rail 700 may linearly extend in the third direction DR3. The fourth guide rail 700 may be connected to (e.g., slidably engaged with) the third guide rail 600. In an embodiment, the fourth guide rail 700 may linearly move in the second direction DR2 by the third guide rail 600. That is, the fourth guide rail 700 may be movable in the second direction DR2 or a direction opposite to the second direction DR2 along the third guide rail 600. In an embodiment, for example, the fourth guide rail 700 may be movable in the maintenance area MA and the stage area SA in the second direction DR2 or the direction opposite to the second direction DR2 along the third guide rail 600.

The discharger 800 may be arranged on the fourth guide rail 700. The discharger 800 may extend in the second direction DR2. The discharger 800 may be connected to (e.g., slidably engaged with) the fourth guide rail 700. In an embodiment, the discharger 800 may linearly move in the third direction DR3 by the fourth guide rail 700. That is, the discharger 800 may be movable in the third direction DR3 or the direction opposite to the third direction DR3 along the fourth guide rail 700. In an embodiment, for example, the discharger 800 may be movable in the maintenance area MA and the stage area SA in the third direction DR3 or the direction opposite to the third direction DR3 along the fourth guide rail 700.

In such an embodiment, as the second, third, and fourth guide rails 500, 600, and 700 and the discharger 800 are connected to each other, the discharger 800 may be movable in the first, second, and third directions DR1, DR2, and DR3 by the second, third, and fourth guide rails 500, 600, and 700. That is, the discharger 800 may be movable in the first direction DR1 or the direction opposite to the first direction DR1 by the second guide rail 500, may be movable in the second direction DR2 or the direction opposite to the second direction DR2 by the third guide rail 600, and may be movable in the third direction DR3 or the direction opposite to the third direction DR3 by the fourth guide rail 700.

The third stage structure 900 may be arranged in the stage area SA on the plate 10. In an embodiment, for example, the third stage structure 900 may be fixed in the third area SA3 on the plate 10. The third stage structure 900 may define the third area SA3. The third stage structure 900 may provide a space that accommodates a portion of the first guide rail 100 and the second stage structure 300 in the third area SA3.

In an embodiment, each of the first, second, third, and fourth guide rails 100, 500, 600, and 700 may be a linear motion system.

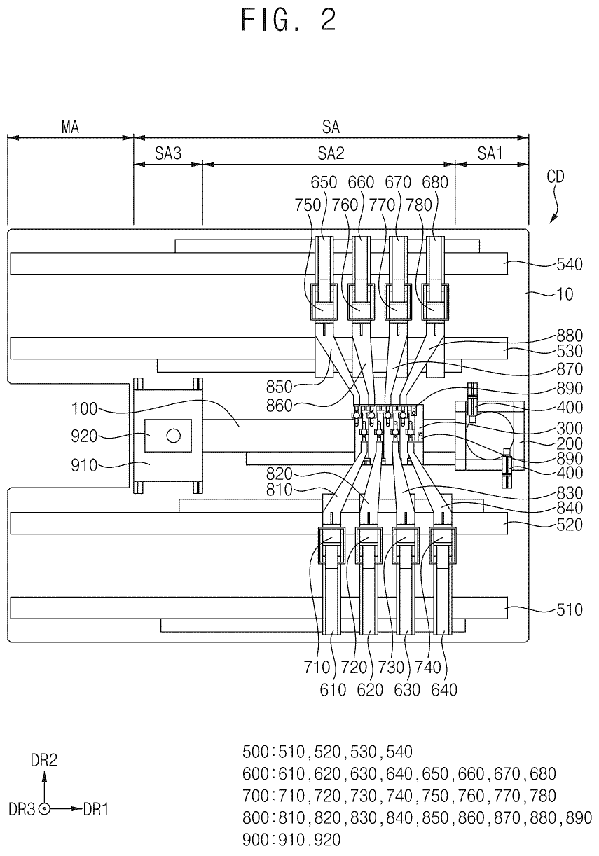

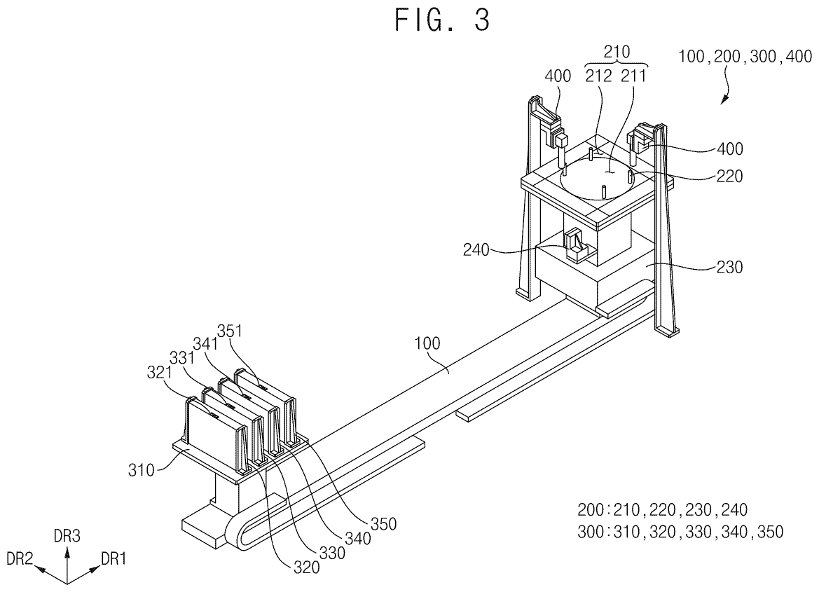

FIG. 2 is a plan view illustrating the coating device of FIGS. 1A and 1B. FIGS. 3, 4, and 5 are perspective views illustrating components included in the coating device of FIGS. 1A and 1B.

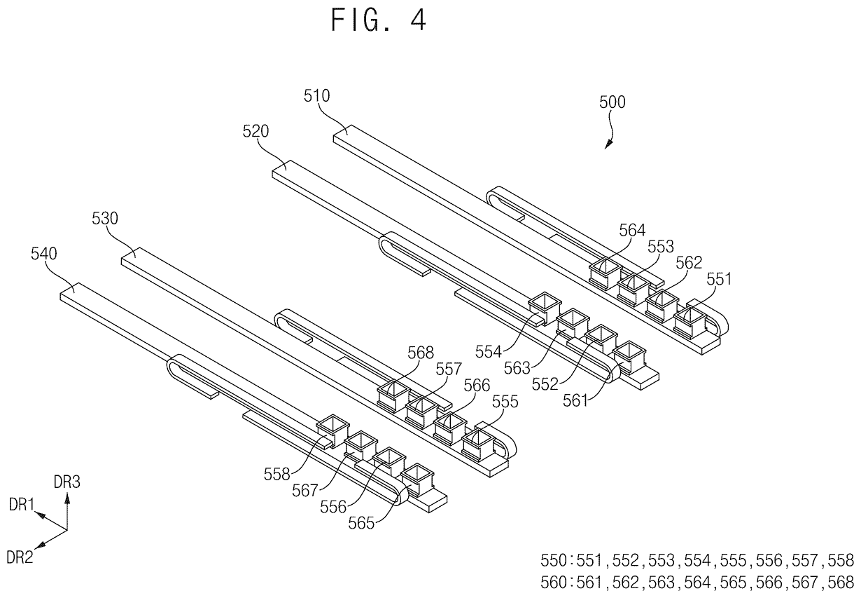

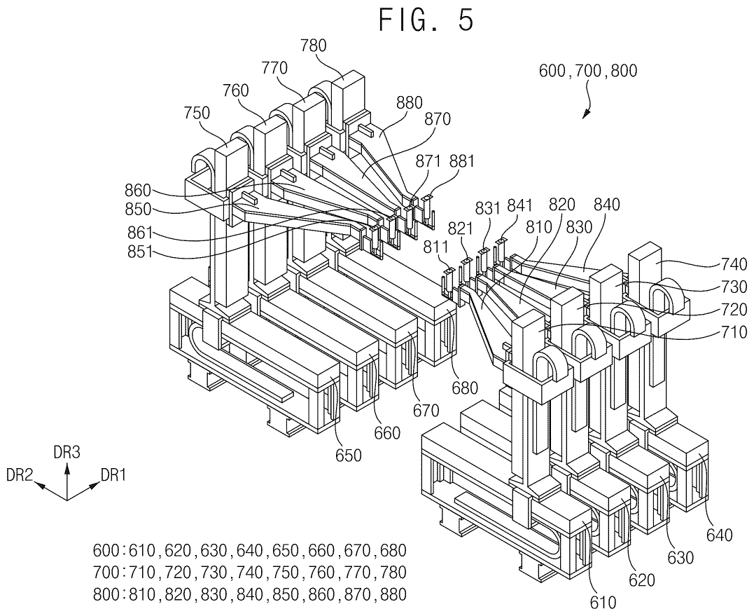

Particularly, FIG. 3 may be a perspective view illustrating the first guide rail 100, the first and second stage structures 200 and 300, and the imager 400 included in the coating device CD, FIG. 4 may be a perspective view illustrating the second guide rail 500 included in the coating device CD, and FIG. 5 may be a perspective view illustrating the third and fourth guide rails 600 and 700 and the discharger 800 included in the coating device CD.

Referring to FIGS. 2, 3, 4, and 5, an embodiment of the coating device CD may include the first, second, third, and fourth guide rails 100, 500, 600, and 700, the first, second, and third stage structures 200, 300, and 900, the imager 400, and the discharger 800 arranged on the plate 10.

The first stage structure 200 may be arranged on the first guide rail 100, and may be connected to (e.g., slidably engaged with) the first guide rail 100. The first stage structure 200 may include a first stage 210, a lift pin 220, an aligner 230, and an inspector 240.

The first stage 210 may be (e.g., have a surface) parallel to the plane defined by first and second directions DR1 and DR2. The first stage 210 may include a substrate area 211 and a dummy area 212 adjacent to the substrate area 211. In an embodiment, for example, the dummy area 212 may surround the substrate area 211 in a plan view. The substrate area 211 may be an area on which the object is seated, and the dummy area 212 may be an area in which a dummy shot of the coating device CD is performed. Although FIG. 3 illustrates an embodiment where the substrate area 211 has a circular planar shape, the disclosure is not limited thereto, and a shape of the substrate area 211 may be variously changed depending on a shape of the object or the like.

The lift pin 220 may be arranged in the substrate area 211 of the first stage 210. The lift pin 220 may support the object, and may be driven when the object is carried in or out. The lift pin 220 may move in the third direction DR3 or in the direction opposite to the third direction DR3. In an embodiment, for example, when the object is carried in, the lift pin 220 may be driven in the direction opposite to the third direction DR3 to seat the object on the first stage 210, and when the object is carried out, the lift pin 220 may be driven in the third direction DR3 to remove the object from the first stage 210.

The aligner 230 may be arranged below the first stage 210. The aligner 230 may align (or adjust a position of) the object seated on the first stage 210. In an embodiment, for example, the aligner 230 may correct alignment, position, or the like of the object based on an alignment mark of the object captured by the imager 400. In an embodiment, for example, the aligner 230 may be a UVW stage that may be driven with respect to the plane defined by the first and second directions DR1 and DR2.

The inspector 240 may be arranged below the first stage 210. In an embodiment, for example, the inspector 240 may be arranged between the first stage 210 and the aligner 230. The inspector 240 may inspect state, alignment, position, or the like of the discharger 800, and may correct alignment, position, or the like of the discharger 800. The inspector 240 may capture an image in the third direction DR3. In an embodiment, for example, the inspector 240 may capture an image of at least a portion of the discharger 800 (e.g., nozzles 811, 821, 831, 841, 851, 861, 871, and 881). In an embodiment, for example, the inspector 240 may include a camera module, and may be provided in plural or multiple units.

The second stage structure 300 may be arranged on the first guide rail 100, and may be connected to (e.g., slidably engaged with) the first guide rail 100. The second stage structure 300 may include a second stage 310 and a cassette. The second stage 310 may be (or have a surface) parallel to the plane defined by the first and second directions DR1 and DR2.

The cassette may be arranged on the second stage 310. The cassette may be provided in plural or multiple units. In an embodiment, for example, the cassette may include first, second, third, and fourth cassettes 320, 330, 340, and 350. The first, second, third, and fourth cassettes 320, 330, 340, and 350 may be arranged along the first direction DR1. The first, second, third, and fourth cassettes 320, 330, 340, and 350 may include first, second, third, and fourth cleaning portions 321, 331, 341, and 351, respectively. The first, second, third, and fourth cleaning portions 321, 331, 341, and 351 may be defined on upper portions of the first, second, third, and fourth cassettes 320, 330, 340, and 350, respectively. The first, second, third, and fourth cassettes 320, 330, 340, and 350 may clean nozzles 811, 821, 841, 851, 861, 871, and 881 of the discharger 800. The first, second, third, and fourth cassettes 320, 330, 340, and 350 may each include a roll wiper therein, and may clean the nozzles 811, 821, 831, 841, 851, 861, 871, and 881 of the discharger 800 through the first, second, third, and fourth cleaning portions 321, 331, 341, and 351.

The first stage structure 200 and the second stage structure 300 may be driven independently of each other on the first guide rail 100. That is, the first and second stage structures 200 and 300 may be driven simultaneously, or only one of the first and second stage structures 200 and 300 may be driven. In an embodiment, for example, while the object is carried in or carried out from the first stage structure 200 in first area SA1 on the first guide rail 100, the second stage structure 300 may clean the nozzles 811, 821, 831, 841, 851, 861, 871, and 881 of the discharger 800 in the second area SA2 on the first guide rail 100.

The imager 400 may be arranged in the first area SA1. The imager 400 may capture an image of at least a portion of the object seated on the first stage 210. In an embodiment, for example, the imager 400 may capture an image of the alignment mark of the object. In an embodiment, for example, where two imagers 400 are provided, the imagers 400 may be spaced apart from each other, and the first guide rail 100 may be arranged between the imagers 400 in a plan view or when viewed in the third direction DR3.

The second guide rail 500 may include a rail and a connection portion. In an embodiment, for example, the second guide rail 500 may include first, second, third, and fourth rails 510, 520, 530, and 540 and first and second connection portions 550 and 560.

Each of the first, second, third, and fourth rails 510, 520, 530, and 540 may linearly extend in the first direction DR1, and may be arranged along the second direction DR2. Some of the first, second, third, and fourth rails 510, 520, 530, and 540 may be spaced apart from the first guide rail 100 in the second direction DR2, and others of the first, second, third, and fourth rails 510, 520, 530, and 540 may be spaced apart from the first guide rail 100 in the direction opposite to the second direction DR2. In an embodiment, for example, the first and second rails 510 and 520, the first guide rail 100, and the third and fourth rails 530 and 540 may be sequentially arranged along the second direction DR2.

The first and second connection portions 550 and 560 may be arranged on the first, second, third, and fourth rails 510, 520, 530, and 540. The first and second connection portions 550 and 560 may be portions connected to the third guide rail 600. In an embodiment, for example, the first connection portion 550 may be a portion that moves the third guide rail 600, and the second connection portion 560 may be a portion that supports the third guide rail 600. In an embodiment, for example, the first connection portion 550 may include a coil, and the second connection portion 560 may not include a coil. Each of first and second connection portions 550 and 560 may be provided in plural or multiple units. In an embodiment, for example, the first connection portion 550 may include first, second, third, fourth, fifth, sixth, seventh, and eighth movement connection portions 551, 552, 553, 554, 556, 557, and 558, and the second connection portion 560 may include first, second, third, fourth, fifth, sixth, seventh, and eighth support connection portions 561, 562, 563, 564, 565, 566, 567, and 568.

In an embodiment, the first and second connection portions 550 and 560 may be alternately arranged along the first direction DR1 on the first, second, third, and fourth rails 510, 520, 530, and 540. In an embodiment, for example, the first movement connection portion 551, the second support connection portion 562, the third movement connection portion 553, and the fourth support connection portion 564 may be arranged along the first direction DR1 on the first rail 510. The first support connection portion 561, the second movement connection portion 552, the third support connection portion 563, and the fourth movement connection portion 554 may be arranged along the first direction DR1 on the second rail 520. The fifth movement connection portion 555, the sixth support connection portion 566, the seventh movement connection portion 557, and the eighth support connection portion 568 may be arranged along the first direction DR1 on the third rail 530. The fifth support connection portion 565, the sixth movement connection portion 556, the seventh support connection portion 567, and the eighth movement connection portion 558 may be arranged along the first direction DR1 on the fourth rail 540.

The third guide rail 600 may be arranged on the second guide rail 500, and may be connected to the second guide rail 500. In an embodiment, for example, the third guide rail 600 may include fifth, sixth, seventh, eighth, ninth, tenth, eleventh, and twelfth rails 610, 620, 630, 640, 660, 670, and 680, and each of the fifth, sixth, seventh, eighth, ninth, tenth, eleventh, and twelfth rails 610, 620, 630, 640, 650, 660, 670, and 680 may be connected to the second guide rail 500.

Each of the fifth, sixth, seventh, eighth, ninth, tenth, eleventh, and twelfth rails 610, 620, 630, 640, 650, 660, 670, and 680 may extend in the second direction DR2. In an embodiment, each of the fifth, sixth, seventh, eighth, ninth, tenth, eleventh, and twelfth rails 610, 620, 630, 640, 650, 660, 670, and 680 may be connected to two rails of the second guide rail 500. In an embodiment, for example, each of the fifth, sixth, seventh, and eighth rails 610, 620, 630, and 640 may be connected to the first and second rails 510 and 520, and each of the ninth, tenth, eleventh, and twelfth rails 650, 660, 670, and 680 may be connected to the third and fourth rails 530 and 540. The fifth, sixth, seventh, and eighth rails 610, 620, 630, and 640 may be arranged along the first direction DR1 on the first and second rails 510 and 520, and the ninth, tenth, eleventh, and twelfth rails 650, 660, 670, and 680 may be arranged along the first direction DR1 on the third and fourth rails 530 and 540.

In an embodiment, for example, the fifth rail 610 may be connected to the first movement connection portion 551 and the first support connection portion 561, the sixth rail 620 may be connected to the second movement connection portion 552 and the second support connection portion 562, the seventh rail 630 may be connected to the third movement connection portion 553 and the third support connection portion 563, and the eighth rail 640 may be connected to the fourth movement connection portion 554 and the fourth support connection portion 564. The ninth rail 650 may be connected to the fifth movement connection portion 555 and the fifth support connection portion 565, the tenth rail 660 may be connected to the sixth movement connection portion 556 and the sixth support connection portion 566, the eleventh rail 670 may be connected to the seventh movement connection portion 557 and the seventh support connection portion 567, and the twelfth rail 680 may be connected to the eighth movement connection portion 558 and the eighth support connection portion 568.

The fifth, sixth, seventh, eighth, ninth, tenth, eleventh, and twelfth rails 610, 620, 630, 640, 650, 660, 670, and 680 may be driven independently of each other on the second guide rail 500. That is, the fifth, sixth, seventh, eighth, ninth, tenth, eleventh, and twelfth rails 610, 620, 630, 640, 660, 670, and 680 may be driven simultaneously, or at least one selected from the fifth, sixth, seventh, eighth, ninth, tenth, eleventh, and twelfth rails 610, 620, 630, 640, 650, 660, 670, and 680 may be driven.

The fourth guide rail 700 may be arranged on the third guide rail 600, and may be connected to the third guide rail 600. In an embodiment, for example, the fourth guide rail 700 may include thirteenth, fourteenth, fifteenth, sixteenth, seventeenth, eighteenth, nineteenth, and twentieth rails 710, 720, 730, 740, 750, 760, 770, and 780, and each of the thirteenth, fourteenth, fifteenth, sixteenth, seventeenth, eighteenth, nineteenth, and twentieth rails 710, 720, 730, 740, 750, 760, 770, and 780 may be connected to the third guide rail 600.

Each of the thirteenth, fourteenth, fifteenth, sixteenth, seventeenth, eighteenth, nineteenth, and twentieth rails 710, 720, 730, 740, 750, 760, 770, and 780 may extend in the third direction DR3. In an embodiment, for example, the thirteenth, fourteenth, fifteenth, sixteenth, seventeenth, eighteenth, nineteenth, and twentieth rails 710, 720, 730, 740, 750, 760, 770, and 780 may be connected to the fifth, sixth, seventh, eighth, ninth, tenth, eleventh, and twelfth rails 610, 620, 630, 640, 650, 660, 670, and 680, respectively. The thirteenth, fourteenth, fifteenth, and sixteenth rails 710, 720, 730, and 740 may be arranged along the first direction DR1 on the fifth, sixth, seventh, and eighth rails 610, 620, 630, and 640, and the seventeenth, eighteenth, nineteenth, and twentieth rails 750, 760, 770, and 780 may be arranged along the first direction DR1 on the ninth, tenth, eleventh, and twelfth rails 650, 660, 670, and 680.

The thirteenth, fourteenth, fifteenth, sixteenth, seventeenth, eighteenth, nineteenth, and twentieth rails 710, 720, 730, 740, 750, 760, 770, and 780 may be driven independently of each other on the third guide rail 600. That is, the thirteenth, fourteenth, fifteenth, sixteenth, seventeenth, eighteenth, nineteenth, and twentieth rails 710, 720, 730, 740, 750, 760, 770, and 780 may be driven simultaneously, or at least one selected from the thirteenth, fourteenth, fifteenth, sixteenth, seventeenth, eighteenth, nineteenth, and twentieth rails 710, 720, 730, 740, 750, 760, 770, and 780 may be driven.

The discharger 800 may be arranged on the fourth guide rail 700, and may be connected to (e.g., slidably engaged with) the fourth guide rail 700. In an embodiment, for example, the discharger 800 may include first, second, third, fourth, fifth, sixth, seventh, and eighth heads 810, 820, 830, 840, 850, 860, 870, and 880 that each discharges a droplet. Each of the first, second, third, fourth, fifth, sixth, seventh, and eighth heads 810, 820, 830, 840, 850, 860, 870, and 880 may be connected to the fourth guide rail 700.

Each of the first, second, third, fourth, fifth, sixth, seventh, and eighth heads 810, 820, 830, 840, 850, 860, 870, and 880 may extend from the fourth guide rail 700 in a direction toward the first guide rail 100. In an embodiment, for example, the first, second, third, fourth, fifth, sixth, seventh, and eighth heads 810, 820, 830, 840, 850, 860, 870, and 880 may be connected to the thirteenth, fourteenth, fifteenth, sixteenth, seventeenth, eighteenth, nineteenth, and twentieth rails 710, 720, 740, 750, 760, 770, and 780, respectively. The first, second, third, and fourth heads 810, 820, 830, and 840 may be arranged along the first direction DR1 on the thirteenth, fourteenth, fifteenth, and sixteenth rails 710, 720, 730, and 740, and the fifth, sixth, seventh, and eighth heads 850, 860, 870, and 880 may be arranged along the first direction DR1 on the seventeenth, eighteenth, nineteenth, and twentieth rails 750, 760, 770, and 780. The first, second, third, and fourth heads 810, 820, 830, and 840 may extend in the second direction DR2 or a direction substantially similar thereto, and the fifth, sixth, seventh, and eighth heads 850, 860, 870, 870, and 880 may extend in the direction opposite to the second direction DR2 or a direction substantially similar thereto.

Each of the first, second, third, fourth, fifth, sixth, seventh, and eighth heads 810, 820, 830, 840, 850, 860, 870, and 880 may include a nozzle that discharges a droplet. In an embodiment, each head may include a single nozzle. However, the disclosure is not limited thereto, and each head may include two or more nozzles in another embodiment. The first, second, third, fourth, fifth, sixth, seventh, and eighth heads 810, 820, 830, 840, 850, 860, 870, and 880 may include first, second, third, fourth, fifth, sixth, seventh, and eighth nozzles 811, 821, 831, 841, 841, 851, 861, 871, and 881, respectively. Each of the first, second, third, fourth, fifth, sixth, seventh, and eighth nozzles 811, 821, 831, 841, 861, 871, and 881 may discharge a droplet in the direction opposite to the third direction DR3 toward the object seated on the first stage 210.

The first, second, third, fourth, fifth, sixth, seventh, and eighth heads 810, 820, 830, 840, 850, 860, 870, and 880 may be driven independently of each other. That is, the first, second, third, fourth, fifth, sixth, seventh, and eighth heads 810, 820, 830, 840, 850, 860, 870, and 880 may be driven simultaneously, or at least one selected from the first, second, third, fourth, fifth, sixth, seventh, and eighth heads 810, 820, 830, 840, 850, 860, 870, and 880 may be driven.

In an embodiment, for example, the first head 810 may be movable in each of the first, second, and third directions DR1, DR2, and DR3 by the first, second, fifth, and thirteenth rails 510, 520, 610, and 710. The second head 820 may be movable in each of the first, second, and third directions DR1, DR2, and DR3 by the first, second, sixth, and fourteenth rails 510, 520, 620, and 720. The third head 830 may be movable in each of the first, second, and third directions DR1, DR2, and DR3 by the first, second, seventh, and fifteenth rails 510, 520, 630, and 730. The fourth head 840 may be movable in each of the first, second, and third directions DR1, DR2, and DR3 by the first, second, eighth, and sixteenth rails 510, 520, 640, and 740. The fifth head 850 may be movable in each of the first, second, and third directions DR1, DR2, and DR3 by the third, fourth, ninth, and seventeenth rails 530, 540, 650, and 750. The sixth head 860 may be movable in each of the first, second, and third directions DR1, DR2, and DR3 by the third, fourth, tenth, and eighteenth rails 530, 540, 660, and 760. The seventh head 870 may be movable in each of the first, second, and third directions DR1, DR2, and DR3 by the third, fourth, eleventh, and nineteenth rails 530, 540, 670, and 770. The eighth head 880 may be movable in each of the first, second, and third directions DR1, DR2, and DR3 by the third, fourth, twelfth, and twentieth rails 530, 540, 680, and 780.

In an embodiment, the discharger 800 may further include a sensor 890. The sensor 890 may be connected to at least one selected from the first, second, third, fourth, fifth, sixth, seventh, and eighth heads 810, 820, 830, 840, 850, 860, 870, and 880. In an embodiment, for example, the sensor 890 may be connected to each of the fourth and eighth heads 840 and 880. The sensor 890 may measure volume, area, shape, or the like of a dropped droplet. In an embodiment, for example, the sensor 890 may measure droplets discharged from the fourth and eighth nozzles 841 and 881 and dropped on the first stage 210. In an embodiment, for example, the sensor 890 may be a confocal sensor.

The third stage structure 900 may be arranged in the third area SA3. The third stage structure 900 may include a third stage 910 and a measurer 920.

The third stage 910 may be (have a surface) parallel to the plane defined by first and second directions DR1 and DR2. The third stage 910 may be spaced apart from the first guide rail 100 in the third direction DR3, and may at least partially overlap the first guide rail 100 in a plan view.

The measurer 920 may be arranged on the third stage 910. The measurer 920 may measure weight of a dropped droplet. In an embodiment, for example, the measurer 920 may measure droplets discharged from the first, second, third, fourth, fifth, sixth, seventh, and eighth nozzles 811, 821, 831, 841, 851, 861, 871, and 881 and dropped on the measurer 920. The measurer 920 may be provided in one or more units. In an embodiment, for example, the measurer 920 may be an electronic scale.

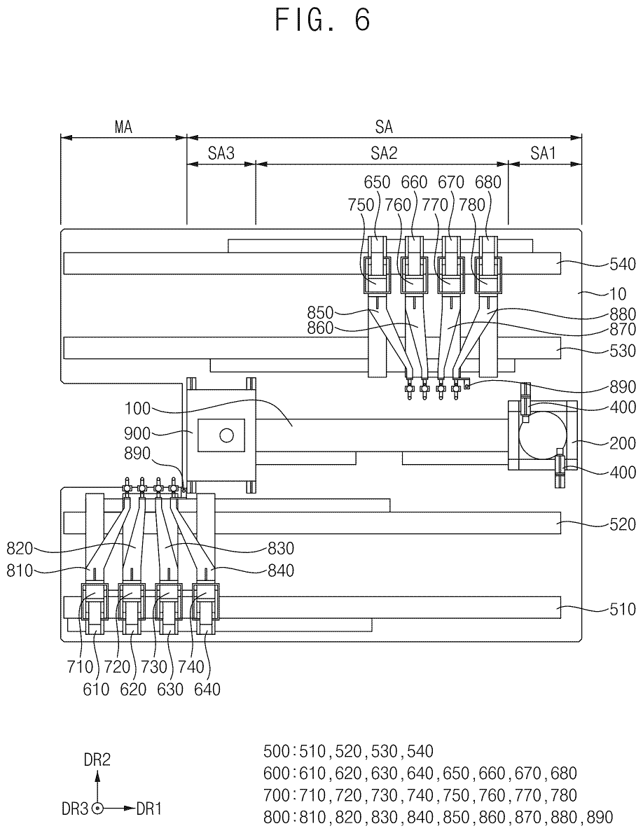

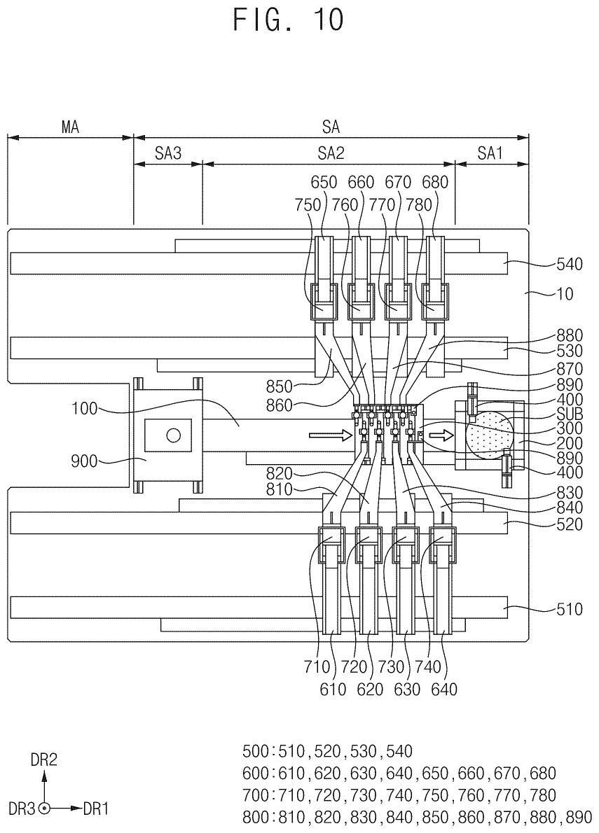

FIGS. 6, 7, 8A, 8B, 9, and 10 are plan views illustrating a method of driving a coating device according to an embodiment of the disclosure. A method of driving a coating device described with reference to FIGS. 6, 7, 8A, 8B, 9, and 10 may be a method of driving the coating device CD described with reference to FIGS. 1A, 1B, 2, 3, 4, and 5. Hereinafter, any repetitive detailed descriptions of the same or like elements as those described above will be omitted or simplified.

Referring to FIG. 6, in an embodiment of a method of driving a coating device, maintenance of the coating device CD may be performed in the maintenance area MA. In an embodiment, for example, maintenance of the discharger 800 may be performed in the maintenance area MA. In an embodiment, for example, replacement of the first, second, third, fourth, fifth, sixth, seventh, and eighth heads 810, 820, 830, 840, 850, 860, 870, and 880, replacement of components included in the first, second, third, fourth, fifth, sixth, seventh, and eighth heads 810, 820, 830, 840, 850, 860, 870, and 880 (e.g., syringe, nozzle, or the like) may be performed in the maintenance area MA. In an embodiment, a component on which maintenance is to be performed may be moved to the maintenance area MA.

In an embodiment, for example, referring to FIG. 6, when performing maintenance on the first, second, third, and fourth heads 810, 820, 830, and 840, the first, second, third, and fourth heads 810, 820, 830, and 840 may be moved toward the maintenance area MA by the first and second rails 510 and 520. In this case, maintenance on the first, second, third, and fourth heads 810, 820, 830, and 840 may be performed by an operator in the maintenance area MA.

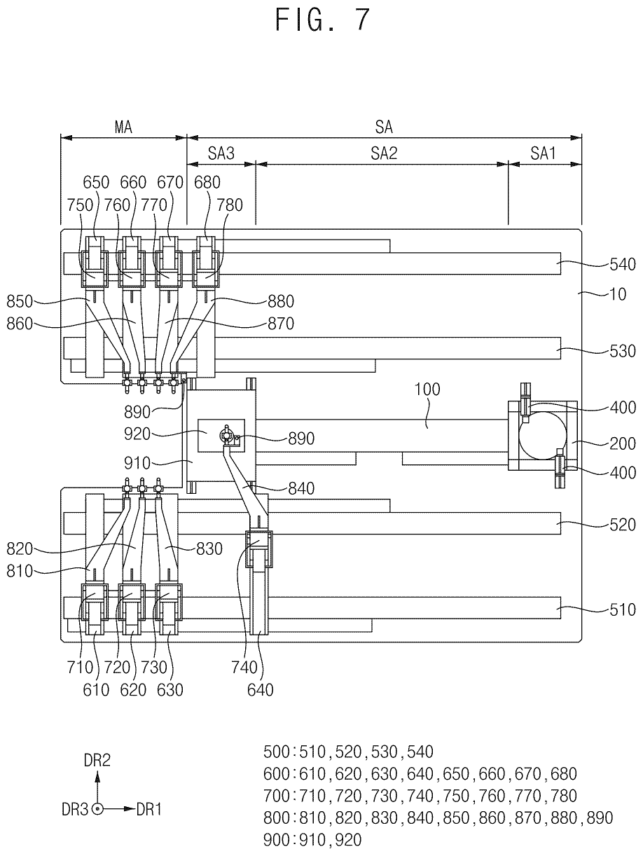

Referring to FIGS. 5 and 7, measurement on a droplet coated (or applied) by the coating device CD may be performed. In an embodiment, for example, measurement on a droplet discharged from the discharger 800 and dropped on the measurer 920 may be performed by the measurer 920. The measurer 920 may measure a weight of the dropped droplet. In an embodiment, a component that discharges a droplet on which measurement is performed may be moved onto the measurer 920.

In an embodiment, for example, referring to FIG. 7, when performing measurement on a droplet discharged by the fourth head 840, the fourth head 840 may be moved by the first and second rails 510 and 520 toward the third area SA3, and may be moved by the eighth rail 640 in a way such that the fourth nozzle 841 is arranged on the measurer 920 or to overlap the measurer 920 in the third direction DR3. The fourth nozzle 841 may discharge a droplet toward the measurer 920, and measurement on the dropped droplet may be performed by the measurer 920.

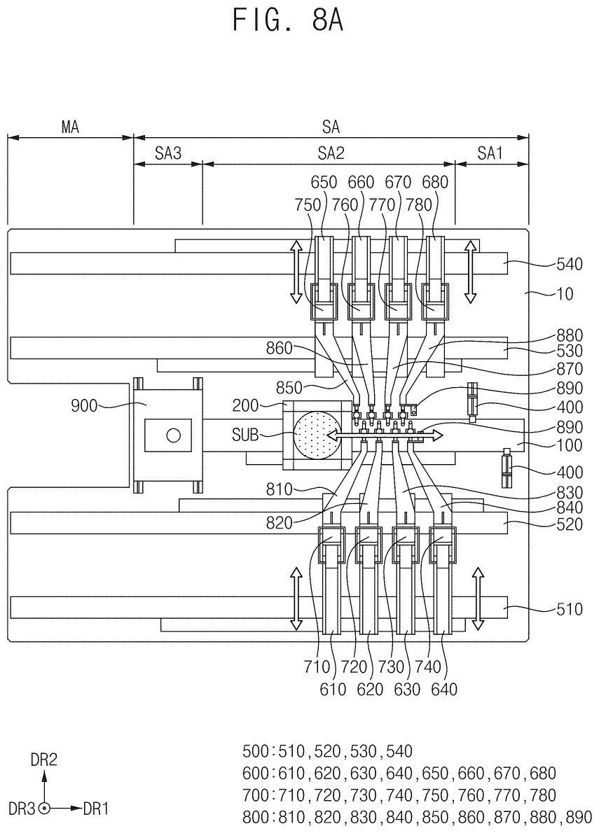

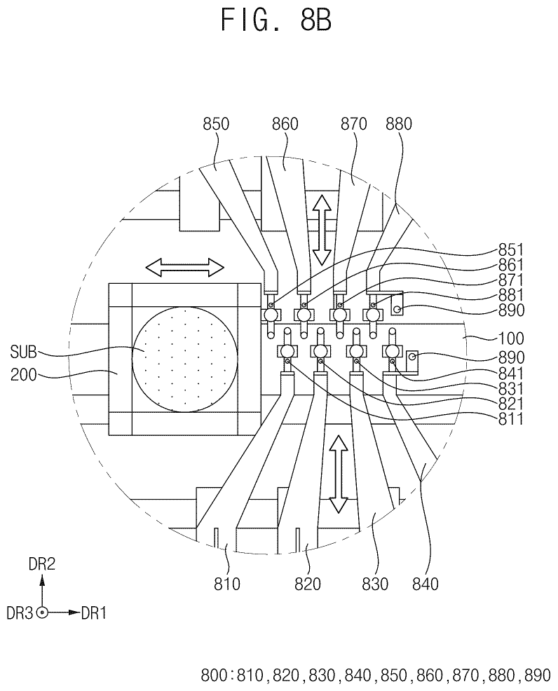

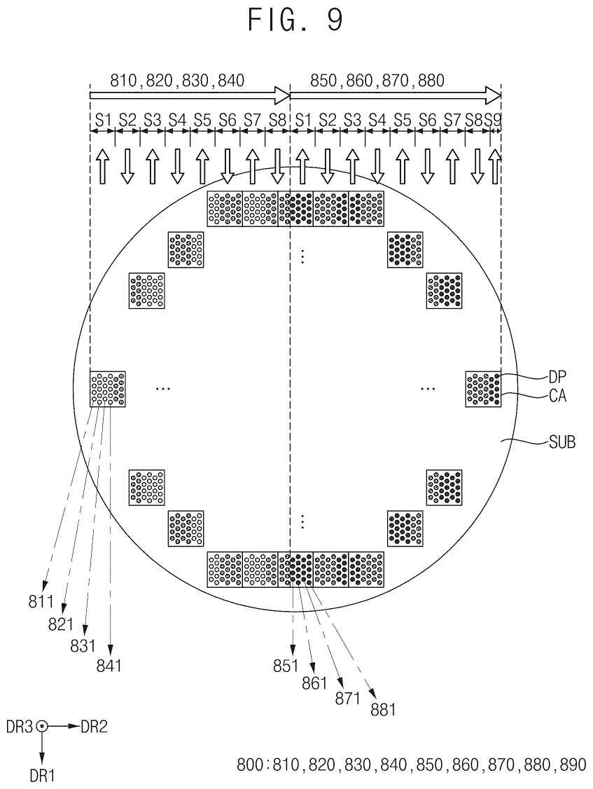

Referring to FIGS. 8A, 8B, and 9, coating by the coating device CD may be performed. In an embodiment, for example, coating in which the discharger 800 discharges droplets DP on a substrate SUB seated on the first stage structure 200 may be performed. The substrate SUB may correspond to the object.

The substrate SUB may include cell areas CA. The cell areas CA may be repeatedly arranged along the first direction DR1 and the second direction DR2, and the cell areas CA may define a selected pattern in which the droplets DP are discharged by the coating device CD.

The substrate SUB carried into the coating device CD may be seated on the first stage structure 200 in the first area SA1. The first stage structure 200 on which the substrate SUB is seated may be moved to the second area SA2 along the first guide rail 100. In addition, the discharger 800 may be moved to the second area SA2 along the second guide rail 500, and the first, second, third, fourth, fifth, sixth, seventh, and eighth heads 810, 820, 830, 840, 850, 860, 870, and 880 may be aligned along the third and fourth guide rails 600 and 700 according to the selected pattern to be formed on the substrate SUB.

In an embodiment, some of the first, second, third, fourth, fifth, sixth, seventh, and eighth heads 810, 820, 830, 840, 850, 860, 870, and 880 may form a portion of the selected pattern, and others of the first, second, third, fourth, fifth, sixth, seventh, and eighth heads 810, 820, 830, 840, 850, 860, 870, and 880 may form another portion of the selected pattern. In an embodiment, for example, the first, second, third, and fourth heads 810, 820, 830, and 840 may form approximately half of the selected pattern, and the fifth, sixth, seventh, and eighth heads 850, 860, 870, and 880 may form approximately another half of the selected pattern.

In an embodiment, for example, the first, second, third, and fourth heads 810, 820, 830, and 840 may form a pattern from a first side of the substrate SUB to an area adjacent to a center of the substrate SUB in the second direction DR2, and the fifth, sixth, seventh, and eighth heads 850, 860, 870, and 880 may form a pattern from an area adjacent to the center of the substrate SUB to a second side opposite to the first side of the substrate SUB in the second direction DR2.

In an embodiment, for example, the first, second, third, and fourth heads 810, 820, 830, and 840 may form a pattern from an area adjacent to the center of the substrate SUB to the first side of the substrate SUB in the direction opposite to the second direction DR2, and the fifth, sixth, seventh, and eighth heads 850, 860, 870, and 880 may form a pattern from the second side of the substrate SUB to an area adjacent to the center of the substrate SUB in the direction opposite to the second direction DR2.

Each of the first, second, third, fourth, fifth, sixth, seventh, and eighth nozzles 811, 821, 831, 841, 851, 861, 871, and 881 may form a column pattern in the first direction DR1. In an embodiment, for example, first, second, third, and fourth column patterns discharged from the first, second, third, and fourth nozzles 811, 821, 831, and 841 may be arranged along the second direction DR2, and fifth, sixth, seventh, and eighth column patterns discharged from the fifth, sixth, seventh, and eighth nozzles 851, 861, 871, and 881 may be arranged along the second direction DR2.

In an embodiment, for example, the first nozzle 811 may form the first column pattern, the second nozzle 821 may form the second column pattern adjacent to the first column pattern in the second direction DR2, the third nozzle 831 may form the third column pattern adjacent to the second column pattern in the second direction DR2, and the fourth nozzle 841 may form the fourth column pattern adjacent to the third column pattern in the second direction DR2. The fifth nozzle 851 may form the fifth column pattern, the sixth nozzle 861 may form the sixth column pattern adjacent to the fifth column pattern in the second direction DR2, the seventh nozzle 871 may form the seventh column pattern adjacent to the sixth column pattern in the second direction DR2, and the eighth nozzle 881 may form the eighth column pattern adjacent to the seventh column pattern in the second direction DR2.

In an embodiment, the first stage structure 200 on which the substrate SUB is seated may be repeatedly moved in the first direction DR1 and the direction opposite to the first direction DR1 in the second area SA2. That is, the first stage structure 200 on which the substrate SUB is seated may reciprocally move in the first direction DR1 and the direction opposite to the first direction DR1 below the first, second, third, fourth, fifth, sixth, seventh, and eighth nozzles 811, 821, 831, 841, 851, 861, 871, and 881.

While the first stage structure 200 repeatedly moves in the second area SA2, the discharger 800 may discharge the droplets DP toward the substrate SUB to form the selected pattern on the substrate SUB. Here, a process in which the substrate SUB passes below the first, second, third, fourth, fifth, sixth, seventh, and eighth nozzles 811, 821, 831, 841, 851, 861, 871, and 881 in one direction may be defined as a ‘scan’. In an embodiment, for example, where the first, second, third, fourth, fifth, sixth, seventh, and eighth nozzles 811, 821, 841, 841, 861, 871, and 881 discharge the droplets DP toward the substrate SUB, a pattern of eight columns may be formed in one scan. Multiple scans may be performed to form the selected pattern.

In an embodiment, after one scan is performed, the first, second, third, fourth, fifth, sixth, seventh, and eighth heads 810, 820, 830, 840, 850, 860, 870, and 880 may be moved in the second direction DR2 or the opposite direction to the second direction DR2.

In an embodiment, for example, referring to FIG. 9, when the substrate SUB includes the cell areas CA of first, second, third, fourth, fifth, sixth, seventh, eighth, ninth, tenth, and eleventh columns and each of the cell areas CA includes first, second, third, fourth, fifth, and sixth column patterns (i.e., when the selected pattern includes first to sixty-sixth column patterns), first to thirty-second column patterns may be formed by the first, second, third, and fourth heads 810, 820, 830, and 840, and thirty-third to sixty-sixth column patterns may be formed by the fifth, sixth, seventh, and eighth heads 850, 860, 870, and 880. In other words, patterns of the cell areas CA of the first to fifth columns and first and second column patterns of the cell area CA of the sixth column may be formed by the first, second, third, and fourth heads 810, 820, 830, and 840, and third to sixth column patterns of the cell area CA of the sixth column and patterns of the cell areas CA of the seventh to eleventh columns may be formed by the fifth, sixth, seventh, and eighth heads 850, 860, 870, and 880.

In an embodiment, for example, first, a first scan S1 in which the substrate SUB (i.e., the first stage structure 200) moves in the direction opposite to the first direction DR1 in the second area SA2 may be performed. In this case, the first, second, third, and fourth nozzles 811, 821, 831, and 841 may form a pattern of four columns on the first side of the substrate SUB, and the fifth, sixth, seventh, and eighth nozzles 851, 861, 871, and 881 may form a pattern of four columns on an area adjacent to the center of the substrate SUB. That is, the first, second, third, and fourth nozzles 811, 821, 831, and 841 may form the first, second, third, and fourth column patterns, and the fifth, sixth, seventh, and eighth nozzles 851, 861, 871, and 881 may form the thirty-third, thirty-fourth, thirty-fifth, and thirty-sixth column patterns. As the substrate SUB moves in the direction opposite to the first direction DR1, the patterns of four columns may be formed along the first direction DR1. After the first scan S1 is performed, the first, second, third, fourth, fifth, sixth, seventh, and eighth heads 810, 820, 830, 840, 850, 860, 870, and 880 may be moved in the second direction DR2.

Next, a second scan S2 in which the substrate SUB moves in the first direction DR1 in the second area SA2 may be performed. In this case, the first, second, third, and fourth nozzles 811, 821, 831, and 841 may form a pattern of four columns adjacent to the pattern of four columns formed by the first, second, third, and fourth nozzles 811, 821, 831, and 841 in the first scan S1, and the fifth, sixth, seventh, and eighth nozzles 851, 861, 871, and 881 may form a pattern of four columns adjacent to the pattern of four columns formed by the fifth, sixth, seventh, and eighth nozzles 851, 861, 871, and 881 in the first scan S1. That is, the first, second, third, and fourth nozzles 811, 821, 831, and 841 may form the fifth, sixth, seventh, and eighth column patterns, and the fifth, sixth, seventh, and eighth nozzles 851, 861, 871, and 881 may form the thirty-seventh, thirty-eighth, thirty-ninth, and fortieth column patterns. As the substrate SUB moves in the first direction DR1, the patterns of four columns may be formed in the direction opposite to the first direction DR1. After the second scan S2 is performed, the first, second, third, fourth, fifth, sixth, seventh, and eighth heads 810, 820, 830, 840, 850, 860, 870, and 880 may be moved in the second direction DR2.

In such an embodiment, third, fourth, fifth, sixth, seventh, and eighth scans S3, S4, S5, S6, S7, and S8 may be performed, and after the eighth scan S8 is performed, at least one selected from the fifth, sixth, seventh, and eighth heads 850, 860, 870, and 880 may be moved in the second direction DR2. In an embodiment, for example, the fifth and sixth heads 850 and 860 may be moved in the second direction DR2. In this case, the fifth and sixth nozzles 851 and 861 may form a pattern of two columns adjacent to a pattern of four columns formed by the fifth, sixth, seventh, and eighth nozzles 851, 861, 871, and 881 in the eighth scan S8. That is, the fifth and sixth nozzles 851 and 861 may form the sixty-fifth and sixty-sixth column patterns. Accordingly, after the first, second, third, fourth, fifth, sixth, seventh, eighth, and ninth scans S1, S2, S3, S4, S5, S6, S7, S8, and S9 are performed, the selected pattern in which the droplets DP are coated to the cell areas CA of the substrate SUB may be formed.

However, the disclosure is not limited thereto, and a number of the cell areas CA, a shape of a pattern defined in the cell areas CA, a number of nozzles (i.e., a number of heads) included in the discharger 800, or the like may be variously changed, and accordingly, a number of scans to form a selected pattern on the substrate SUB may also be variously changed.

In an embodiment, since the first, second, third, fourth, fifth, sixth, seventh, and eighth heads 810, 820, 830, 840, 850, 860, 870, and 880 may be independently moved in the first, second, and third directions DR1, DR2, and DR3 by the second, third, and fourth guide rails 500, 600, and 700, a shape of a pattern formed on the substrate SUB may be variously changed.

Although FIGS. 8A, 8B, and 9 illustrates an embodiment where the droplets DP are discharged by each of the first, second, third, fourth, fifth, sixth, seventh, and eighth heads 810, 820, 830, 840, 850, 860, 870, and 880, the disclosure is not limited thereto. In an embodiment, during the coating process, the droplets DP may be discharged by at least one selected from the first, second, third, fourth, fifth, sixth, seventh, and eighth heads 810, 820, 830, 840, 850, 860, 870, and 880, for example, the droplets DP may be discharged only by the first, second, third, and fourth heads 810, 820, 830, and 840, or the droplets DP may be discharged only by the fifth, sixth, seventh, and eighth heads 850, 860, 870, and 880.

Referring to FIGS. 3, 5, and 10, cleaning of the coating device CD may be performed. In an embodiment, for example, cleaning of the first, second, third, fourth, fifth, sixth, seventh, and eighth nozzles 811, 821, 831, 841, 851, 861, 871, and 881 that discharge droplets may be performed by the second stage structure 300.

After the coating is performed, the first, second, third, fourth, fifth, sixth, seventh, and eighth heads 810, 820, 830, 840, 850, 860, 870, and 880 may be aligned by the second, third, and fourth guide rails 500, 600, and 700 in a way such that cleaning may be performed in the second area SA2. In addition, the first stage structure 200 on which the substrate SUB is seated may be moved from the second area SA2 to the first area SA1 by the first guide rail 100, and the second stage structure 300 may be moved from the third area SA3 to the second area SA2 by the first guide rail 100. The second stage structure 300 may be moved to be arranged below the first, second, third, fourth, fifth, sixth, seventh, and eighth heads 810, 820, 830, 840, 850, 860, 870, and 880. In an embodiment, the first and second stage structures 200 and 300 may be simultaneously moved along the first guide rail 100.

The first, second, third, fourth, fifth, sixth, seventh, and eighth nozzles 811, 821, 831, 841, 851, 861, 871, and 881 may be cleaned by first, second, third, and fourth cleaning portions 321, 331, 341, and 351. In an embodiment, for example, after the first, second, third, and fourth nozzles 811, 821, 831, and 841 are cleaned by the first, second, third, and fourth cleaning portions 321, 331, 341, and 351, the fifth, sixth, seventh, and eighth nozzles 851, 861, 871, and 881 may be cleaned by the first, second, third, and fourth cleaning portions 321, 331, 341, and 351.

In an embodiment, while cleaning of the first, second, third, fourth, fifth, sixth, seventh, and eighth nozzles 811, 821, 831, 841, 851, 861, 871, and 881 is performed, the substrate SUB on which coating is performed and moved to the first area SA1 may be carried out of the coating device CD, and a substrate SUB on which coating is to be performed may be carried in the coating device CD. That is, cleaning of the first, second, third, fourth, fifth, sixth, seventh, and eighth nozzles 811, 821, 831, 841, 861, 871, and 881 may be performed simultaneously with carrying in or carrying out the substrate SUB. After the cleaning is performed, the second stage structure 300 may be moved back from the second area SA2 to the third area SA3 by the first guide rail 100.

The coating device CD according to an embodiment of the disclosure may include the first, second, third, and fourth guide rails 100, 500, 600, and 700 and the discharger 800 including the first, second, third, fourth, fifth, sixth, seventh, and eighth heads 810, 820, 830, 840, 850, 860, 870, and 880. In such an embodiment, the coating device CD may have a relatively simple structure and may not include a separate gantry structure, such that particles that may be generated while driving the coating device CD may be minimized, and access to maintenance may be improved. In addition, since the first, second, third, fourth, fifth, sixth, seventh, and eighth heads 810, 820, 830, 840, 860, 860, 870, and 880 may be driven independently and moved in the first, second, and third directions DR1, DR2, and DR3 by the second, third, and fourth guide rails 500, 600, and 700, respectively, productivity of the coating device CD may be improved.

Embodiments of the disclosure may be applied to a manufacturing process of various display devices and electronic devices. For example, the disclosure is applicable to a manufacturing process of various display devices such as display devices for vehicles, ships and aircraft, portable communication devices, display devices for exhibition or information transmission, medical display devices, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A coating device comprising:
a first guide rail arranged in a stage area and extending in a first direction;
a second guide rail arranged in the stage area and a maintenance area adjacent to the stage area and extending in the first direction;
a first stage structure arranged on the first guide rail and movable in the first direction or in a direction opposite to the first direction by the first guide rail;
a second stage structure arranged on the first guide rail and movable in the first direction or in the direction opposite to the first direction by the first guide rail; and
a discharger arranged on the second guide rail and movable in the first direction or in the direction opposite to the first direction by the second guide rail.

2. The coating device of claim 1, further comprising:
a third guide rail arranged on the second guide rail and extending in a second direction intersecting the first direction,
wherein the discharger is movable in the second direction or in a direction opposite to the second direction by the third guide rail.

3. The coating device of claim 2, further comprising:
a fourth guide rail arranged on the third guide rail and extending in a third direction intersecting each of the first direction and the second direction,
wherein the discharger is movable in the third direction or in a direction opposite to the third direction by the fourth guide rail.

4. The coating device of claim 3, wherein
the discharger includes a plurality of heads each including a nozzle, and
each of the plurality of heads is connected to the second guide rail, the third guide rail, and the fourth guide rail.

5. The coating device of claim 4, wherein the plurality of heads is movable independently of each other.

6. The coating device of claim 4, wherein
the first stage structure includes a stage on which a substrate is seated, and
the second stage structure includes a cassette which cleans the nozzle.

7. The coating device of claim 2, wherein the second guide rail includes:
a first connection portion which is connected to the third guide rail and moves the third guide rail; and
a second connection portion which is connected to the third guide rail and supports the third guide rail.

8. The coating device of claim 7, wherein the first connection portion and the second connection portion are arranged alternately with each other along the first direction.

9. The coating device of claim 1, further comprising:
an imager arranged in the stage area; and
a third stage structure arranged in the stage area and including a measurer.

10. The coating device of claim 9, wherein
the stage area includes:
a first area;
a second area adjacent to the first area; and
a third area adjacent to the second area,
the imager is arranged in the first area, and
the third stage structure is arranged in the third area.

11. The coating device of claim 10, wherein
the first stage structure is movable in the first area and the second area, and
the second stage structure is movable in the second area and the third area.

12. A method of driving a coating device, the method comprising:
maintaining a discharger in a maintenance area;
measuring a droplet discharged from the discharger in a stage area adjacent to the maintenance area;
coating the droplet on a substrate seated on a first stage structure in the stage area; and
cleaning the discharger in the stage area.

13. The method of claim 12, wherein
the first stage structure is movable in a first direction or in a direction opposite to the first direction by a first guide rail, and
the first guide rail extends in the first direction in the stage area.

14. The method of claim 13, wherein
the discharger is movable in the first direction or in the direction opposite to the first direction by a second guide rail, and
the second guide rail extends in the first direction in the maintenance area and the stage area.

15. The method of claim 14, wherein
the discharger is movable in a second direction intersecting the first direction or in a direction opposite to the second direction by a third guide rail, and
the third guide rail is arranged on the second guide rail and extends in the second direction.

16. The method of claim 15, wherein
the discharger is movable in a third direction intersecting each of the first direction and the second direction or in a direction opposite to the third direction by a fourth guide rail, and
the fourth guide rail is arranged on the third guide rail and extends in the third direction.

17. The method of claim 15, wherein the coating the droplet on the substrate seated on the first stage structure includes:
moving the first stage structure in the first direction;
moving the discharger in the second direction; and
moving the first stage structure in the direction opposite to the first direction.

18. The method of claim 13, wherein
in the cleaning the discharger, the discharger is cleaned by a second stage structure, and
the second stage structure includes a cassette and is movable in the first direction or in the direction opposite to the first direction by the first guide rail.

19. The method of claim 18, wherein the cleaning the discharger includes:
moving the first stage structure in the first direction along the first guide rail; and
moving the second stage structure in the first direction along the first guide rail.

20. The method of claim 19, wherein the moving the first stage structure and the moving the second stage structure are performed simultaneously with each other.
